(19) United States
(12) Patent Application Publication
(10) Pub. No.: US 2025/0225465 A1
(43) Pub. Date: Jul. 10, 2025

(54) SYSTEMS AND METHODS FOR ARTIFICIAL INTELLIGENCE BASED GEOPOLITICAL RISK ASSESSMENT AND ALERTING

(71) Applicant: JUMPTUIT FINANCE, INC., New York, NY (US)

(72) Inventor: Donald Leka, New York, NY (US)

(21) Appl. No.: 19/012,843

(22) Filed: Jan. 7, 2025

Related U.S. Application Data
(60) Provisional application No. 63/618,355, filed on Jan. 7, 2024.

(51) Int. Cl. G06Q 10/0635; G06Q 10/04

(52) U.S. Cl. CPC G06Q 10/0635; G06Q 10/04

(57) ABSTRACT

One embodiment of a method comprises continuously collecting cross-sector data related to geopolitical risk from a worldwide network to update a risk assessment dataset the comprises a series of risk assessment states for a plurality of geopolitical entities in time increments; selecting forecasting risk assessment data from the risk assessment dataset; processing the forecasting risk assessment data using an inquisitive artificial intelligence engine to identify a pattern and trend in the forecasting risk assessment data and use the pattern and trend to forecast risk assessment variable values for an first entity; and generating a user interface comprising an interactive map for a user, the interactive map embodying the forecasted risk assessment variable values to display a forecasted risk for the first entity to the user in association with the first entity in the user interface.

### RELATED APPLICATIONS

This application claims the benefit of priority under 35 U.S.C. § 119(e) of U.S. Provisional Application 63/618,355, entitled “SYSTEMS AND METHODS FOR AI ASSISTED GEOPOLITICAL RISK ASSESSMENT,” filed Jan. 7, 2023, which is hereby fully incorporated by reference herein.

### TECHNICAL FIELD

The present disclosure relates to artificial intelligence systems. More particularly, the present disclosure relates to artificial intelligence for predicting and providing notifications of risks across geographic regions.

### BACKGROUND

Geopolitical events such as wars, terrorist attacks, social unrest, abrupt changes in power, economic tensions, and political tensions can adversely affect important global stakeholders such as intergovernmental organizations, global companies, international charities, and intermediaries in global financial markets (e.g., Society for Worldwide Interbank Financial Telecommunication (SWIFT), T2 Wholesale Payment System, Real-Time Gross Settlement (RTGS), Clearing House Interbank Payments System (CHIPS), clearinghouses, settlement banks, correspondent banks, and payment service providers (PSPs). Disruptive events can greatly impact an international organization's ability to operate in an area, disrupt its supply chains, payroll, and ability to engage in financial transactions, threaten its equipment and infrastructure, and threaten the health and safety of its people. In an era of growing geopolitical instability, geopolitical risk management has become increasingly important for global organizations, particularly when determining whether to commit or withdraw people and assets. However, there are few tools to assess geopolitical risk.

Caldara, Dario and Matteo lacoviello (2018), Measuring Geopolitical Risk, International Finance Discussion Papers, p. 1222, proposes a geopolitical risk (GPR) index created with an algorithm that counts the frequency of articles related to geopolitical risks in leading international newspapers published in the United States, the United Kingdom, and Canada. The GPR index is constructed monthly using newspaper records. The GPR index thus captures geopolitical risks as perceived and chronicled by the press in English-speaking countries, particularly in the United States. The GPR index is based on searching for a limited set of keywords related to geopolitical risk and provides a rough proxy for global risk at an earlier time.

The Fund for Peace Corporation publishes a yearly “Fragile States Index” that incorporates several indicators of risk. The Fragile States Index is published yearly, does not assess interstate risk between individual entities, and involves substantial analysis by human reviewers to independently review countries and provide assessments.

While prior generative artificial intelligence (AI) can categorize and summarize, prior generative AI paradigms have shortcomings with respect to predicting geopolitical risk. First, these AI systems typically rely on a large body of training data that is specifically labeled by humans to train the Al to carry out a task and the feedback loop for new learning/retraining often includes sending the results generated by AI to annotators for relabeling and then retraining the AI using the reviewer labeled data. Indeed, an entire industry has developed to farm training data to annotators around the world for labeling/relabeling. Geopolitical events, however, can be extremely dynamic, with changes occurring in a matter of days, hours, or less and can result in new patterns that are not adequately captured in the labeled historical data.

Some generative AI systems are connected to a web search engine and incorporate search results when generating content. Such systems rely on the information to already be publicly available over the Internet and the search engine to have crawled and indexed the information. Thus, the search results may not reflect the most current information. Moreover, because search results may include incorrect or contrary information, the output of the generative AI is many times of poor quality or nonsensical. Consequently, such generative AI systems are not sufficient for assessing and generating notifications of geopolitical risk.

It is thus logistically infeasible for prior generative AI systems to monitor and forecast geopolitical risks near instantaneously and to be free from mislabeling and misinformation.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore non-limiting, embodiments illustrated in the drawings, wherein identical reference numerals designate the same components. Note that the features illustrated in the drawings are not necessarily drawn to scale.

FIG. 1 is a diagrammatic representation of one embodiment of a computer environment for artificial intelligence (AI)-based risk assessment and alerts.

FIGS. 2A-2H are diagrammatic representations of embodiments of a user interface.

FIG. 3 is a flowchart illustrating one embodiment of a method of AI-assisted risk assessment and alerting.

FIG. 4 is a diagrammatic representation of one embodiment of a computer network environment.

### WRITTEN DESCRIPTION

Various aspects of the disclosure are described more fully below with reference to the accompanying drawings, which form a part hereof, and which show specific exemplary aspects. However, different aspects of the disclosure may be implemented in many different forms and should not be construed as limited to the aspects set forth herein; rather, these aspects are provided so that this disclosure will be thorough and complete, and will fully convey the scope of the aspects to those skilled in the art. Aspects may be practiced as methods, systems or devices. Accordingly, aspects may take the form of a hardware implementation, an entirely software implementation or an implementation combining software and hardware aspects. The following detailed description is, therefore, not to be taken in a limiting sense.

Embodiments of the present disclosure provide real-time, observation-based learning AI systems and methods for artificial intelligence (AI)-based geopolitical risk (AIGPR) assessment and alerting. An AIGPR system applies artificial intelligence and machine learning to provide services related to GPR assessment. More particularly, the AIGPR system uses clusters of cross-sectional signals to agnostically observe the dynamic movement of variables across sectors, including the appearance/disappearance of variables, in real-time or near real-time, to recognize patterns and trends and assess risk with high confidence. Risk assessments can trigger notifications, including alerts, for entities (e.g., nation states or other entities). Geopolitical risk assessments and notifications may be generated, in some cases, using hyper-localized data.

The AIGPR system exhibits innate inquisitiveness, spontaneously generating queries to acquire data in order to understand what combinations of cross-sector factors are responsible for fluctuations in geopolitical dynamics and environmental conditions, and forecasting potential impacts on global political and economic systems and financial markets, including, for example, determining probable disruptive events and other risks that may threaten the health and safety of people or property, allowing decisionmakers to withdraw personnel or assets or avoid committing them into potential danger.

The AIGPR system, according to one embodiment, synchronizes global observation of atmospheric, terrestrial, and oceanic conditions, human activity, and artificial systems across geographic regions, jurisdictions and sectors, continuously collecting real-time data in increments of milliseconds, seconds, minutes, days, weeks and months depending on data source. The AIGPR system can continuously run cross-sector risk analyses to discover and understand different combinations of cross-sector risk variables that can threaten global political and economic systems and financial markets and to increase the speed and improve the accuracy of future forecasts.

AIGPR system can thus continuously learn through the uninterrupted observation of cross-sector conditions and dynamically generated queries in response to observed changes in conditions to provide live assessments of collected cross-sector data and dynamic, observation-based forecasting of future conditions, risks and opportunities.

One embodiment includes a method for artificial intelligence (AI)-based global geopolitical risk assessment and warning. The method may include continuously collecting cross-sector data related to geopolitical risk from a worldwide network of data sources to update a risk assessment dataset comprising a series of risk assessment states for a plurality of geopolitical entities in time increments, selecting forecasting risk assessment data from the risk assessment dataset for assessing risk for a selected time increment and a first entity from the plurality of geopolitical entities, processing the forecasting risk assessment data using an inquisitive artificial intelligence engine to identify a pattern and trend in the forecasting risk assessment data and use the pattern and trend to forecast risk assessment variable values for the first entity to generate forecasted risk assessment variable data, wherein the comprises a forecasted value for at least one indicator geopolitical risk to the first entity; and dynamically generating a user interface comprising an interactive map for a user, the interactive map embodying the forecasted risk assessment variable values to display a forecasted risk for the first entity to the user in association with the first entity in the user interface.

Another example embodiment includes a system for artificial intelligence (AI)-based global geopolitical risk assessment and warning. The system may comprise a processor, a volatile memory coupled to the processor, and a second memory coupled to the processor storing a granular dynamic risk assessment dataset collected from a worldwide network of data sources, comprising a series of risk assessment states for a plurality of geopolitical entities in time increments. The system may also include code executable to provide an inquisitive artificial intelligence engine. The code may comprise instructions for receiving an indication to generate a forecast for a first entity and first time increment, loading into the volatile memory, forecasting risk assessment data for a defined time increment, the risk assessment data comprising data indicative of geopolitical risk, analyzing by the inquisitive artificial intelligence engine the forecasting risk assessment to identify a pattern and trend in the forecasting risk assessment data and use the pattern and trend to forecast risk assessment variable values for the first entity to generate forecasted risk assessment variable values, the forecasted risk assessment variable values comprising at least one of an indication of a probable disruptive event, an intrastate stability score, an interstate stress score, and dynamically generating a user interface comprising an interactive map for a user, the interactive map embodying the forecasted risk assessment variable values to display a forecasted risk for the first entity to the user in association with the first entity in the user interface.

Another embodiment includes a non-transitory, computer-readable medium embodying thereon computer-executable code. The computer-executable code, according to one embodiment, comprises instructions for maintaining a granular dynamic risk assessment dataset collected from a worldwide network of data sources, comprising a series of risk assessment states for a plurality of geopolitical entities in time increments, receiving an indication to generate a forecast for a first entity and first increment, loading into volatile memory, forecasting risk assessment data for a defined time increment, the forecasting risk assessment data comprising data indicative of geopolitical risk, analyzing by an inquisitive artificial intelligence engine the forecasting risk assessment to identify a pattern and trend in the forecasting risk assessment data and use the pattern and trend to forecast risk assessment variable values for the first entity to generate forecasted risk assessment variable data, the forecasted risk assessment variable values comprising at least one of an indication of a probable disruptive event, an intrastate stability score, an interstate stress score, and dynamically generating a user interface comprising an interactive map for a user, the interactive map embodying the forecasted risk assessment variable values to display a forecasted risk for the first entity to the user in association with the first entity in the user interface.

Embodiments of the present application can provide a technical advantage by providing real-time or near real-time forecasts of risk and alerts by agnostically observing cross-sector signals from a wide variety of data sources with high confidence.

Embodiments of the present application can provide another technical advantage by processing clusters of signals to detect events, thereby reducing effects of misinformation.

Embodiments of the present application can further provide a technical advantage by continuously running cross-sector risk analyses to discover and understand different combinations of cross-sector risk and improve the accuracy of future forecasts.

Embodiments of the present application can provide another advantage by implementing learning and feedback that reduces or eliminates the need for human intervention.

Embodiments of the present application can provide another technical advantage by actively accessing and using data from hyperlocal sources to identify events more quickly.

Embodiments of the present application can provide another technical advantage by spontaneously generating queries to data sources to collect additional data to confirm, augment, or understand patterns.

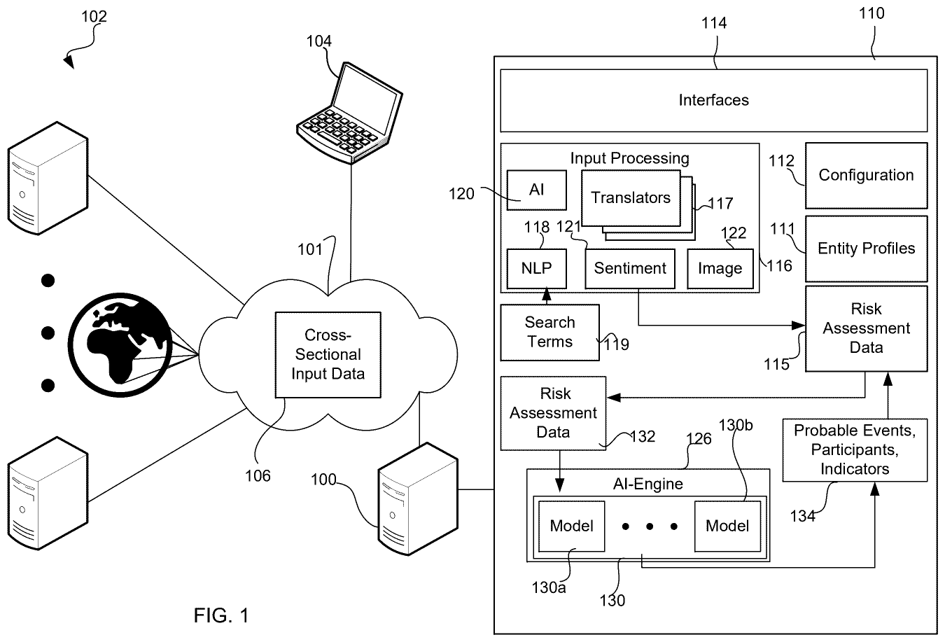

FIG. 1 is a diagrammatic representation of one embodiment of an AIGPR system 100 and related computer environment. In the computer environment of FIG. 1, AIGPR system 100 is coupled to data sources 102 and client devices (e.g., client device 104) by a network 101, which comprises the Internet, a wide area network, a local area network, wired network, or wireless network, including combinations of such networks in some embodiments.

According to one embodiment, AIGPR system 100 comprises a computer system executing an AIGPR application 110 that comprises one or more applications embodied as instructions on a computer readable medium where the instructions are executable to cause AIGPR system 100 to perform at least some of the functionality associated with embodiments described herein. According to one embodiment, the computer system comprises one or more cloud computer systems running a cloud-based AIGPR application. In some embodiments, AIGPR application 110 implements one or more of the following risk assessments: forecasting an event with high confidence; forecasting a risk indicator; or identifying behavior in new alignments/blocks. Forecasting an event includes, in one embodiment, forecasting one or more of a probable disruptive event or an action (e.g., an escalatory/de-escalatory action).

According to one embodiment, AIGPR application 110 implements AI to forecast one or more probable disruptive events with high confidence. AIGPR application 110, may also anticipate the participants for at least one probable disruptive event. Disruptive events affect political systems, economic systems, and financial markets. Disruptive events can involve violence or the potential for violence, threaten data, disrupt trade, disrupt monetary movement, impact economies, and undermine governments. Examples of disruptive events include, but are not limited to, social unrest (e.g., protests, demonstrations); ongoing conflicts such as regional conflicts (territorial disputes), wars (e.g., civil wars, interstate wars, proxy wars); political instability; terrorist attacks; cyberattacks; trade tensions and disputes leading to disruptions of trade flows; sovereign debt crises; disruptive capital flows including large-scale-inflows and outflows; currency fluctuations that affect the value of cross-border payments; imposition of sanctions; and the imposition of tariffs.

AIGPR application 110 can detect a wide range of activities related to risk assessment. The activities associated with risk assessment such as detecting disruptive events, determining intrastate stability or determining interstate risk may embody, for example, associations published in research papers or scholarly studies, activities determined by domain experts, activities determined via machine learning or activities otherwise determined. Example activities include, but are not limited to, escalatory/de-escalatory actions.

According to one embodiment, AIGPR application 110 implements AI to forecast one or more actions, such as escalatory/de-escalatory actions, with high confidence. AIGPR application 110 may also anticipate the participants for at least one escalatory/de-escalatory action. Escalatory/de-escalatory actions are actions that tend to escalate or de-escalate tensions between two entities. For example, certain military, economic, and other types of actions can escalate or de-escalate tensions between entities (e.g. affect bilateral stress) and increase/decrease the probability of disruptive events.

Non-limiting examples of military actions include deployment of troops, deployment of troops on borders, cross-border raids, attacks, building of new military facilities, deployment of warships, deployment of fighter jets, deployment of aviation reconnaissance aircraft (e.g., planes, balloons), violations of airspace, increases of purchases of munitions (e.g., chemical munitions, rockets, guided and ballistic missiles, bombs, warheads, mortar rounds, artillery ammunition, small arms ammunition, grenades, mines, torpedoes, depth charges, cluster munitions and dispensers, demolition charges), or increases in stockpiles of munitions (e.g., chemical munitions, rockets, guided and ballistic missiles, bombs, warheads, mortar rounds, artillery ammunition, small arms ammunition, grenades, mines, torpedoes, depth charges, cluster munitions and dispensers, demolition charges).

Non-limiting examples of economic actions include trade embargoes, boycotts, sanctions, tariff discrimination, freezing of capital assets, suspension of financial aid, prohibition of investment and other capital flows, expropriation, cross-border capital controls, freeze on foreign financial assets, liquidation and repatriation of assets held abroad, decreases in trade, reduction in suspension of key imports (e.g., minerals, fuels, food, water), decreases in work visas, and removal or departures from a trade and economic corporation organization.

Escalatory and de-escalatory actions are directional. For example, the United States imposing tariffs on imports with Canada is an escalatory action for Canada with respect to the United States, and Canada imposing export taxes with the United States is an escalatory action for the United States with respect to Canada.

In one embodiment, AIGPR application 110 forecasts values for one or more indicators of risk. In an even more particular embodiment, one or more indicators of risk includes at least one of an indicator of intrastate stability or an indicator of bilateral stress. Some examples of indicators of intrastate stability include an overall intrastate stability indicator, a demographic pressures intrastate stability indicator, a refugees and IDPs intrastate stability indicator, a group grievance intrastate stability indicator, a human flight and brain drain intrastate stability indicator, an economic inequality intrastate stability indicator, an economy (economic decline) intrastate stability indicator, a state legitimacy intrastate stability indicator, a public services intrastate stability indicator, a human rights intrastate stability indicator, a security apparatus intrastate stability indicator, a factionalized elites intrastate stability indicator, and an external pressures intrastate stability indicator. Some examples of indicators of interstate stress include a bilateral stress indicator for an entity and an overall interstate stress indicator for an entity. In some embodiments, an indicator of interstate stress provides an indicator of intrastate stability (e.g., an external pressures intrastate stability indicator).

Indicators of interstate stress for an entity may be determined based on the escalatory/de-escalatory actions for the entity. For example, escalatory/de-escalatory actions determined for a selected entity with respect to another entity may be used in determining a bilateral stress score that indicates the risk that the other entity will engage in activity that will negatively impact the economy or security of the selected entity. A bilateral stress determined for Canada with respect to the United States (e.g., a Canada-US bilateral stress) for example represents the risk that the United States will engage in activity that will negatively impact the economy or security of Canada. Similarly, bilateral stress determined for the United States with respect to Canada (e.g., a US-Canada bilateral stress) represents the risk that Canada will engage in activity that will negatively impact the economy or security of the United States.

The escalatory/de-escalatory actions determined for an entity may be assigned weighted scores and the values added to determine a bilateral stress score for an entity with respect to the other entity. For example, the escalatory action of the United States decreasing trade with Canada is assigned a weighted score and added to Canada's bilateral stress score with respect to the United States. The weighted scores applied to the escalatory/de-escalatory actions may be determined, for example, by domain experts or machine learning and included in the configuration of AIGPR application 110. In one embodiment, an economic bilateral stress score and a military bilateral stress score are determined for an entity with respect to another entity (e.g., a Canada-US economic bilateral stress score and a Canada-US military bilateral stress score are determined for Canada with respect to the United States and combined to produce an overall Canada-US bilateral stress score for Canada with respect to the United States).

While escalatory/de-escalatory actions and bilateral stress scores can be determined for an entity with respect to every other entity or some large number of entities (e.g., every other country), some embodiments may limit the determination of escalatory/de-escalatory actions or bilateral stress scores to a limited set of entities. In one embodiment, for determination of escalatory/de-escalatory actions and bilateral stress scores for an entity is limited to bordering entities (e.g., entities sharing a terrestrial or maritime border), regional entities, and geostrategic entities, where geostrategic entities are a limited set of the most powerful or influential entities. The individual bilateral stress scores are combined into an interstate stress score.

According to one embodiment, AIGPR application 110 implements AI to learn, in an existing order (e.g., set of alliances and associations) the trends of movement of entities in relation to each other based on economic, military, trade agreements, alliances, loans, foreign aid, tariffs, export restrictions, etc. AIGPR application 110, according to one embodiment, implements AI to learn, in a newly established order, new ranges of behavior for nation states and other entities subsequent to an event in relation to their newly formed clusters and in relation to entities in other newly formed clusters.

Assessments performed by AIGPR application 110 depend on the entity for which the assessment is being performed and, in some cases, its relationships with other entities. AIGPR application 110 provides dynamic tracking of entities, such as local, regional and geo-strategic actors (e.g., nation states and other participants (terrorist groups, mercenary groups, etc.), etc.) for AI-based GPR assessment. To this end, AIGPR application 110 includes an entity datastore 111 of entity profiles for entities, such as nations, states, cities, non-state actors (e.g., terrorist groups, mercenary groups), and organizations of interest. An entity profile for a country may include information, such as, but not limited to, for example, entity name, prominent people (e.g., head of state, head of government, military leaders, business leaders), cities, key resources, region, bordering countries (terrestrial and maritime), critical waterways, definitions of economic exclusion zones, membership in alliances, membership in treaties, trade partners, and proxies. In some embodiments, entity datastore 111 embodies relationships between entities. In some embodiments, at least a portion of an entity's profile is collected from one or more data sources 102.

Further AIGPR application includes configuration information 112 specifying, for example, what data sources 102 to query, what data to query from the data sources, and a schedule for querying the data. In some cases, data sources or data to be queried is entity specific, such as for querying hyper-localized data.

AIGPR system 100 connects to various data sources 102 to continually collect input data 106 including data from which risk variable values used for AI-based processing can be extracted or derived and receives inputs from and provides outputs to client devices (e.g., client device 104). To this end, AIGPR application 110 implements one or more interfaces 114 utilized by AIGPR system 100 to gather data from or provide data to client computing devices (e.g., client device 104), data sources 102, databases or other components. It will be understood that the particular interface utilized in a given context depends on the functionality being implemented by AIGPR system 100, the type of network utilized to communicate with any particular system, the type of data to be obtained or presented, the time increment at which data is obtained, the types of systems utilized. Thus, these interfaces may include, for example, web pages, web services, a data entry or database application to which data can be entered or otherwise accessed by an operator, application programming interfaces (APIs), libraries or other types of interfaces which are desired to utilize in a particular context.

Data sources 102 provide public APIs or other public interfaces through which data of interest can be accessed. Some of the data sources may charge a fee to access data, limit the amount of data that can be accessed in a given time period, or otherwise regulate access to data through its interface. Accordingly, AIGPR system 100 may be configured to ingest input data 106 from the data sources based on various schedules, as rate limited by the APIs of the data sources or based on another scheme. AIGPR system 100, in some embodiments, also initiates spontaneous, unscheduled queries to data sources.

While only a few data sources are illustrated in FIG. 1 for simplicity, AIGPR system 100 can collect input data 106 from a large number of data sources (e.g., hundreds or thousands) distributed around the world. Examples of data sources include, but are not limited to: national governments and local governments (e.g., county, city, etc.); international and intergovernmental global organizations (e.g., UN, World Trade Organization, International Monetary Fund, World Health Organization, World Trade Organization, World Bank); non-profit organizations; private organizations; recognized sources of scholarly papers; global data nets (GDNs) news; global sensory intelligence (GSI); hyper-localized news sources (e.g., local national, state/province, county, town, news sources); social media systems. Numerous other sources/types can also be used, as one skilled in the art would understand.

According to one embodiment, AIGPR system 100 has live access to massive real-time, cross-sector data sets through global sensor intelligence (GSI) and global data networks (GDNs) and synchronizes global observation of atmospheric, terrestrial, and oceanic conditions, human activity, and artificial systems across geographic regions, jurisdictions and sectors, continuously collecting real-time data in increments of milliseconds, seconds, minutes, days, weeks and months depending on data source.

Input data 106 includes data from which risk assessment data (e.g., risk assessment variables) can be extracted or derived. The data sources used and data collected depend on the AI services being provided and the variables used by that service. Non-limiting examples of data used in some embodiments includes, but is not limited to the following: alliances (memberships in alliances with other entities) and associations (e.g., associations of the entity with nations or non-nation actors that serve as proxies without a formal alliance); economic index rankings; military index rankings; data indicating the occurrence of disruptive events and, if applicable, parties involved/geographic scope; data on recent activities/engagements, such as, but not limited to data indicating the occurrence of or detection of escalatory/de-escalatory actions and the parties involved; atmospheric, terrestrial, and oceanic conditions; trade partner data (e.g., trade partners, trade volume with trade partners); loans to other entities; loans from other entities; foreign aid to other entities; foreign aid from other entities; tariffs on other entities; tariffs imposed by other entities; export restrictions on other entities; export restrictions by other entities; economic indicator data (gross domestic product (GDP), gross national product (GNP), unemployment, inflation, productivity, debt, poverty level, housing starts, business failures, currency value); capital flight; foreign investment; trade revenue; corruption index ranking (e.g., corruption indexes), money laundering data, embezzlement data; indicators of trade disruption (e.g., shipping disruption, rail disruption, air cargo disruption, ground cargo disruption), such as geolocated tracking data for ships (e.g., automatic identification system (AIS) data) entering/leaving ports of the entity, planes arriving at or departing from airports of the entity, trains moving into/out of or within the entity, cargo trucks moving into/out of or within the entity, counts of port of calls, import volumes and export volumes, reported disruptions; reported values for intrastate stability indicators (e.g., overall intrastate stability indicator, demographic pressures intrastate stability indicator, refugees and IDPs intrastate stability indicator, group grievance intrastate stability indicator, human flight and brain drain intrastate stability indicator, economic inequality intrastate stability indicator, economy (economic decline) intrastate stability indicator, state legitimacy intrastate stability indicator, public services intrastate stability indicator, human rights intrastate stability indicator, security apparatus intrastate stability indicator, factionalized elites intrastate stability indicator, external pressures intrastate stability indicator); infrastructure damage; destruction of infrastructure; public transport strikes; transportation disruptions, such as rail disruption, flight disruption, maritime traffic disruptions; road closures; supply chain disruption; essential services disruption; essential health services disruption; essential healthcare services disruption; school closures; schools destroyed; schools damaged; disruption of sanitation services; loss of drinking water; water shortage; fuel restrictions; rationing of power; power outage; power cuts; loss of power; power grid collapse; loss of telecommunications; telecom hacks; telecom breaches; mobile operator disruption; banking services disruption; hospitals destroyed; hospitals damaged; disruption of internet services; loss of connectivity; police checkpoints; collapse of health systems; bridge collapse; tunnel collapse; loss of security; loss of basic services; rising crime rates; high murder rate; rising murder rate; organized crime; violent crime rate; failing justice system; police overwhelmed; disorganized police force; underfunded police force, cyber-attacks such as, but not limited to cyber-attacks on telecommunications, power systems and transportation.

Some of the data is quantitative and other data qualitative. In many cases, strictly quantitative data of interest is provided by data sources 102 as structured data according to a defined data schema as can be provided, for example, via an API using XML, JSON. In other cases, however, one or more items of data of interest must be inferred from unstructured data, such as text from news releases. For example, many escalatory/de-escalatory behaviors that affect interstate stress are not expressed in structured data. AIGPR system 100 can implement various content processing techniques to extract data of interest from freeform text and images.

Various behaviors and changes to variables can affect intrastate or interstate risks and the likelihoods that events will occur, but international sources may provide data capturing these changes until well after the behavior occurs, if at all. For example, local governments may publish quantitative economic data long before that economic data is reflected in datasets provided by international bodies. As another example, a cross-border raid into a country may be reported in a press release of a city official or in the city's local news before the event surfaces, if at all, to international news sources. AIGPR application 110, according to one embodiment, ingests data from hyper-localized sources, such as systems of local (national, state/province/territory, county, city, town) governments or organizations, sources of press releases by local governments or leaders (government leaders, combatant leaders), speeches of people of interest (e.g., government leaders, combatant leaders), and hyper-localized news aggregation across sectors and geographic areas.

AIGPR application 110, according to one embodiment, ingests text data for various sources, including hyper-localized sources, and processes the text using natural language processing (NPL) to identify relevant behaviors expressed in the text. Similarly, AIGPR application 110, according to one embodiment, ingests images from various sources, including hyper-localized sources, and processes the images using image processing to identify relevant behaviors expressed in the images. Text and images may also be processed for sentiment.

Thus, in one embodiment, AIGPR application 110 is configured to query hyper-localized sources for some input data. For some data of interest, AIGPR application 110 may query multiple sources and use data from multiple sources to extract data of interest. For example, when determining if an escalatory/de-escalatory event occurred between parties, AIGPR application 110 may analyze news stories, press releases, etc. from hyperlocal data sources of both entities for indicators of the escalatory/de-escalatory. Indications of the occurrence of an escalatory/de-escalatory action from the hyperlocal data of the two entities is a stronger indicator of the action than indications of the action from the hyperlocal data of only one the entities. In some embodiments, AIGPR application 110 does not consider an event/action to have occurred unless there are multiple signals confirming the event. In some embodiments, when AIGPR application 110 detects an indication of the occurrence of an event, such as an escalatory/de-escalatory action,

AIGPR system 100 builds and continually updates a granular dynamic risk assessment dataset 115 of risk assessment data associated with an entity. Data in risk assessment dataset 115, according to one embodiment, includes risk assessment variables (e.g., bound risk assessment variables) associated with time increment/entity pairs and may be geolocated by being associated with an entity or locality within an entity or having other associated geographic location data. The risk assessment data for a time increment/entity pair can include non-forecasted variable data (i.e., values considered to be the actual value for that time increment rather than a forecasted value for that time increment), prior forecast risk assessment variable data (i.e., values forecast at a prior time for that time interval), or future forecast risk assessment variable data (i.e., the values forecast during that time increment for a future time increment).

Input processing 116 comprises rules for normalizing and mapping input data 106 from the various data sources 102 to entities and time increments used by AIGPR system 100 and storing data in a format that can be input into AI. AIGPR system 100 thus builds a granular dynamic risk assessment dataset 115 of variables and associated data that are relevant to GPR assessment. Dynamic risk assessment dataset 115, according to one embodiment, includes variable data for each entity. In some cases, variable values are stored in association with the source of the data from which the variable value was extracted or derived and other metadata.

In some embodiments, AIGPR system 100 ingests press releases, news articles, speeches, images, videos and other unstructured content from local data sources of the entities, social media feeds of the entities' leaders, and services that provide relevant content. Input processing 116 includes content transformation and analysis tools, such as translators 117, natural language processing (NPL) 118, generative AI 120, sentiment analysis 121, and image analysis 122 to process unstructured content and extract variables of interest.

According to one embodiment, ingested text can be quantified using NPL 118 or generative AI 120, with content from foreign language sources first being translated to a preferred language (e.g., English) by the appropriate translator. NPL 118 is configured with search terms 119 related to variables of interest. For example, escalatory/de-escalatory actions or other activities may be associated with search terms (e.g., published in research papers or scholarly studies, determined by domain experts, determined via machine learning or activities otherwise determined). AIGPR system 100 evaluates source documents (e.g., press releases, news articles, or other documents) including documents from hyperlocal sources (e.g., press releases by governments of relevant countries or leaders, speeches by leaders, and other documents from hyperlocal sources of relevant entities) for the search terms associated with an activity to detect an indicator of an activity.

In some embodiments, the search terms depend on the entity or entities for which the variable is being extracted. For example, analyzing a document for deployment of troops on border, NPL 118 may use different search terms when extracting the variable for Mexico (e.g., for determining Mex-US bilateral stress) than when extracting the variable for Canada (e.g., to determining Canada-US bilateral stress) as different words may be associated with US/Canada border than with the US/Mexico border.

As another example, press releases, news articles, speeches or other documents may be analyzed using generative Al 120 to summarize the document and output the data of interest according to a defined data schema. For example, a news article can be analyzed with generative AI to output data such as a type of activity, parties, numbers, locations, etc., which can be stored in risk assessment dataset 115.

In some embodiments, when AIGPR application 110 detects an indication of an activity in analyzed data, AIGPR application 110 queries other sources for data to analyze for indicators of the activity. For example, if a “detected violation of airspace” escalatory action with respect to a bordering entity is detected, AIGPR application 110 may query other sources of data from which violations of airspace can be detected to confirm the violation of airspace using multiple signals. The spontaneous queries generated by AIGPR system 100 may depend on the entity for which the event was detected and the type of event.

Content such as speeches, social media content and press releases by leaders and prominent people or groups associated with an entity may be analyzed to determine sentiment toward an entity. For example, speeches, press releases, and social media posts by the President of the United States that mention Canada may be processed using sentiment analysis to generate a sentiment score quantifying the sentiment toward Canada expressed in the analyzed content.

Some variables may be extracted through image analysis. For example, various services provide high resolution satellite images that can be analyzed to identify objects such as warships, aircraft, etc. Thus, in some embodiments, image analysis 122 is applied to images to determine if the images are indicative of an activity (e.g., image analysis to identify ships entering/leaving port, planes arriving at or departing from airports of the entity, trains moving into/out of or within the entity, cargo trucks moving into/out of or within the entity, collapsed bridges, reconnaissance or military aircraft of other entities, violations of airspace). Image analysis 122 may include, in some embodiments, sentiment analysis. Image analysis may be performed on digital photographs or frames of videos.

Data sources 102 may provide data at different levels of temporal or geographic granularity from each other or as used by AIGPR system 100 for GPR analysis. For example, in an embodiment in which AIGPR system 100 uses daily increments, but a data source provides variable data at a per week level of granularity, AIGPR system 100, according to one embodiment, maps the variable data for the week to every day increment corresponding to that hour. On the other hand, if a data source provides data on a per hour level of granularity such that there are 24 samples for every day increment used by AIGPR system 100, AIGPR system 100 may apply various techniques to select the value for the day increment such as, but not limited to using the first sample corresponding to the increment, using the last sample corresponding to the increment, averaging the hourly samples, using the highest value sample, using the lowest value sample or determining the value for an increment according to other rules.

Thus, AIGPR application 110 continuously captures data to update risk assessment dataset 115. Risk assessment dataset 115 represents a series of states of the world at small increments. As new data is ingested for an entity, AIGPR application 110 continuously processes ingested data to update forecasts.

The observations may result in combinations of variables that are new or unfamiliar. AIGPR application 110, according to one embodiment, generates spontaneous, self-generated queries when it observes changes in what is being observed, such as new or unfamiliar combinations of variables and can thus acquire data in order to understand what combinations of cross-sector factors are responsible for fluctuations in geopolitical dynamics. In one embodiment, AIGPR application 110 actively searches for and access data derived from verifiable data sources.

AIGPR application 110 implements an AI engine 126, which is a predictive AI that is capable of identifying patterns in terms of variables that trend together, the sequence/order in which the variables move and the velocity of movement of each respective variable in relation to the other variables. AI engine 126 includes an AI model 130, which may include one or more AI models (e.g., first AI model 130a and a second AI model 130b are indicated. According to one embodiment, first AI model 130a and second AI model 130b comprises a Long Short-Term Memory (LSTM) network trained on a large set of entity associated risk variable data, though other forms of artificial intelligence and combinations of AI networks may be used in other embodiments, though embodiments of AI engine 126 could be implemented in numerous other manners, as one skilled in the art would understand. As will be appreciated, the data used for initial training of AI engine 126 may include historical data that is of limited value and the data may be weighted to limit the influence of older data.

First AI model 130a is trained to forecast at least one of: a probable disruptive event with high confidence, a probable escalatory/de-escalatory action with high confidence; a risk indicator. AI engine 126 loads the risk assessment forecasting data 132 to be analyzed for the forecast (e.g., into volatile memory if not already in volatile memory). According to one embodiment, risk assessment forecasting data 132 includes current/recent variable data (e.g., variable data for times in the last n months, last n weeks, last n minutes, last n seconds, last n milliseconds). If data is missing (e.g., for the most recent time increment because the relevant input data has not yet been queried based on the schedule for querying the data source), AI engine 126 generates spontaneous queries to data sources to access the input data from which the missing risk assessment data can be extracted or derived.

Examples of risk assessment data for forecasting include economic index rankings, military index rankings, disruptive event data, sensor data associated with disruptive events, alliances and associations, and recent activities/engagements. The recent activities/engagements include, in some embodiments, the escalatory/de-escalatory actions determined for the entity. In one embodiment, for example, AI engine 126 loads for a selected entity, disruptive event data of the entity, sensor data associated with disruptive events for the entity, recent activities/engagements (including, for example the escalatory/de-escalatory actions for the entity), military index rankings.

Disruptive events may be related to intrastate stability. Thus, in some embodiments, risk assessment data for probable event forecasting includes variables for assessing intrastate stability/risk. Non-limiting examples of economic variables used to assess intrastate risk include decrease in per capita income, decrease in gross domestic product (GDP), decrease in gross national product (GNP), increase in unemployment, increase in inflation, decrease in productivity, increase in debt, increase in poverty level, decrease in housing starts, increase in business failures, devaluation of currency, capital flight, decrease in foreign investment, decrease in trade revenue, drop in commodity prices, increase in corruption, increase in money laundering, increase in embezzlement.

Other non-limiting examples of variables that may be used to assess intrastate stability/risk include infrastructure damage, destruction of infrastructure, public transport strikes, transportation disruption, road closures, supply chain disruption, essential services disruption, essential health services disruption, essential healthcare services disruption, schools shut down, schools closed, disruption of sanitation services, loss of drinking water, water shortage, fuel restrictions, rationing of power, power outage, cyber-attack, loss of power, loss of telecommunications, telecom hack, telecom data breach, telecommunications cyber-attack, mobile operator disruption, banking services disruption, rail disruption, train disruption, flight disruption, schools destroyed, schools damaged, hospitals destroyed, hospitals damaged, disruption of internet services, loss of connectivity, police checkpoints, collapse of health systems, power grid collapse, power cuts, bridge collapse, tunnel collapse, loss of security, loss of basic services, rising crime rates, high murder rate, rising murder rate, organized crime, high violent crime rate, failing justice system, police overwhelmed, disorganized police force, underfunded police force.

AI engine 126 uses risk assessment data from this limited data set corresponding to the recent time increment to identify patterns in terms of risk assessment variables that trend together, the sequence/order in which the variables move and the velocity of movement of each respective variable in relation to the other variables. From these patterns of variables that trend together, order in which the variables move and the respective velocities, AI engine 126 forecasts the variable values for a time increment and entity (AI forecasted data 134), such as a time increment at which the forecast is requested or a future time increment. Forecasted variable data may include the probability that an event will occur. It can be noted that various events (e.g., disruptive events, escalatory/de-escalatory actions) are entity specific. Thus, a forecasted probable event, such as a forecasted interstate war, may be specific to particular entities (e.g., interstate war with Iran).

According to one embodiment, AI engine 126 determines forecasted bilateral stress scores and an interstate stress score for the selected entity with respect to other entities. In one embodiment, the bilateral stress score is determined using the forecasted escalatory/de-escalatory actions that have a threshold probability of occurring. In another embodiment, the scores assigned to forecasted escalatory/de-escalatory events are further weighted by their probabilities.

In some embodiments, first AI model 130a or another AI model may also be trained to forecast indicators of intrastate stability including, for example, values for risks of internal conflict or potential state collapse. Thus, the risk assessment data for forecasting may include previously determined or ingested indicators of intrastate stability. Example risks of internal conflict or potential state collapse include, but are not limited to demographic pressures, refugees and internally displaced persons (IDPs), group grievance, human flight and brain drain, economic inequality, economy (economic decline), state legitimacy, public services, human rights, security apparatus, factionalized elites and interstate stress.

In some embodiments, first AI model 130a or another AI model may also be trained to forecast sentiment. Thus, the risk assessment data for forecasting may include previously determined sentiments.

As AIGPR system 100 ingests and processes new input data from data sources 102 to update risk assessment dataset 115, AIGPR system 100 can continually compare forecasted data (e.g., probable disruptive events, escalatory/de-escalatory actions, indicators of intrastate stability, sentiment, other forecasted variable values) to the updated risk assessment data to determine a confidence in its forecasting and relearn patterns using the updated data if the forecasting confidence falls below a threshold.

Further, as AIGPR system 100 ingests and processes new input data from data sources 102 to update risk assessment dataset 115, it may identify changes to the data, such as variables appearing or dropping out. AI engine 126 may be configured with rules for generating queries as patterns change, such as which changes trigger queries and the data sources to query to confirm variable values or add additional context to the data being considered. For example, AI engine 126 may determine that the data indicates a “detected violation of airspace” escalatory action with respect to a bordering entity in one time increment and does not indicate a “detected violation of airspace” escalatory action with respect to the bordering entity in the next time increment—that is, the “detected violation of airspace”—has dropped out. Such changes can trigger AI engine 126 to query additional data to confirm no “detected violation of airspace”. The spontaneous queries generated by AIGPR system 100 may depend on the entity for which the variables changed, the variables that dropped out/were added or other criteria. In one embodiment, AI engine 126 may be configured to generate queries to different data sources than the data sources queried according to a schedule for data related to “detection of violation of airspace.”

Assessments generated by the learning models can be presented to a user, in some examples, in the form of information and maps illustrating locations/regions of interest, relationships of entities and their relative importance/relevance, relative power of entities, clusters (e.g., geopolitical alignments) of entities (e.g., nation states), patterns of alignments, etc., as well as trends of such items. Assessments generated by the learning models can be presented in other manners, as one skilled in the art would understand.

In one embodiment, AI engine 126 determines the deltas of indicator values from the last assessment. Based on the indicator values or indicator deltas, AIGPR application 110 determines if automatic alerts should be issued. AIGPR application 110 sends the alerts based on the agreed upon arrangements with clients. In addition, or in the alternative, AIGPR application 110 issues alerts by email, text, web interface or other channel based on forecast disruptive events.

The alerts may be used, for example, to protect cross-border transactions and payment, cross-currency conversions, cross-border financing, investments, trade, and credit from geopolitical shock. Furthermore, the alerts and other outputs by the system can alert decision makers so that the decision makers can withdraw people and equipment before outbreaks of violence or delay committing people and assets until the area of interest stabilizes.

According to one embodiment, second AI model 130b learns in an existing order (set of relationships between entities), the trends of movement of entities in relation to each other based on economic, military, trade agreements, alliances, loans, foreign aid, tariffs, export restrictions.

Relationship activities tracked for input to second AI model 130b. Relationship activities may be the same as, overlap, or be different from the escalatory/de-escalatory actions with respect to probable event forecasting and bilateral stress. In one embodiment, relationship activities include one or more of: changes in trade agreements, changes in trade volume; changes in military alliances; changes in investments, changes in credit and loans, changes in foreign aid; changes in tariffs, changes in export restrictions, and grey zone activity between nation states.

Examples of data sources for risk assessment data for input to second AI model 130b include sources/types of data can include the following, although numerous other sources/types can also be used, as one skilled in the art would understand: official governmental announcements of agreements with other nation states (e.g., bilateral, plurilateral, multilateral agreements); global data nets (GDNs) news regarding impending investments, transactions, and military cooperation between nation states; and hyper-localized news aggregation across sectors and regions to detect grey-zone activity between nation states and other entities.

In the newly established order, AI model 130b learns a new range of behavior for nation states and other entities subsequent to an event in relation to their newly formed clusters and in relation to entities in other newly formed clusters. AI model 130b further measures the space in increments between entities in clusters and between clusters of entities.

The output of AI model 130b can be used to provide a proximity map that indicates dynamic incremental movement of nation states and other entities in relation to each other. In some embodiments, the proximity map may display or convey the following exemplary pieces of information, especially when changes are viewed over time, or changes are shown in real time.
a) existing order of nation states and other entity alignments-Clusters (geopolitical alignments/blocs) of nation states and other entity alignments; economic, military, cultural, religious alignments, alliances, etc.;
b) Event(s)—the probability/occurrence of respective events;
c) Fragmentation/chaos—expected and unexpected behavior of entities, actions, and non-actions;
d) Re-clustering—entities move from their original positions, closer to and further away from each other;
e) Reconstituting into new patterns of alignments—new patterns/clusters/configurations begin to emerge;
f) New order established—new nation state and other entity alignments/blocs.

The placement of entities on the proximity map can include the following considerations. The following provides one non-limiting example of the placement/movement of entities in a proximity map.
a) Entity proximity (space and distance between entities) based on increments that represent economic and military agreements, alliances, loans, foreign aid, tariffs, export restrictions, etc.;
b) 1, 2, and 3 step increments movements can be made depending on the scale of activity and events (e.g., the more significant the activity or event, the greater the entity movement);
c) Larger/equivalent entities move on a 1 to 1 basis in relation to each other;
d) Smaller/equivalent entities move on a 1 to 1 basis in relation to each other;
e) Smaller entities move on a 2 to 1 basis in relation to larger entities (smaller entities toward larger entities);
f) Opposing clusters also move in relation to each other in 1, 2, and 3 step increments movements based on the scale of activity and events.

Various other types of information can also be displayed, as one skilled in the art would understand.

According to some embodiments, AI engine 126 determines probabilities of instability. In one embodiment, AI engine 126 provides entity and cluster advantage/disadvantage spectrum analysis, for example, resulting from new economic, political and military alignments (e.g., an impending US, Saudi Arabia, Israel Agreement would have been disadvantageous to Iran, Russia, China creating increased probability for a destabilizing action by the later against the former). In other words, the learning model can take into account what entities will benefit (or not) from a given event/deal/etc.).

In various embodiments, AIGPR system 100 can provide one or more of the following: probabilities of new regional and global alignment formations, such as imminent new re-alignments based on events; probabilities of disruptions to new regional and global alignment formations, such as an increased probability that the regional and geostrategic powers that stand to lose the most will act to disrupt a deal (e.g., Iran, Russia, China); East-West spectrum analysis, for example, China/Russia—entity movement—US/G7 (e.g., learning models can be trained and configured for learning the direction in which entities are moving on the East-West Axis and the probabilities of new global alignments); probabilities of incremental conflict escalations and a probability of an incremental counter escalation; probabilities of major conflict escalations and a major counter retaliation (e.g., what, who and where); probabilities of escalation and de-escalation—countervailing forces spectrum—for example, considerations may include external interventions —combatant allies (escalation), intergovernmental organizations (de-escalation)—scale default 0 balance: escalation +; de-escalation −; probabilities of combatant leadership domestic political support just prior to an incident (e.g., with strong support—greater latitude in policy response options; with weak support—greater constriction in policy response options); probabilities taking into account rational goals (rational actor) vs. ideological goals (irrational actor)—the more ideological, the more unpredictable and the greater likelihood for regional and geopolitical instability; probabilities taking into account ideological actors—governed by political ideology; nationalist, ethnic, religious forces.

In one embodiment, AIGPR system 100 detects where a probable event could potentially expand to or reach (other countries, regions, etc.). For example, for regional shockwaves—speed, distance, intensity, duration, geolocations are determined (e.g., the effects may be more localized). Similarly, for global shockwaves—speed, distance, intensity, duration, geolocations are determined (e.g., the effects may be less localized). The system can also take the size of an event into account-macro event and micro event shockwaves.

AIGPR system 100 can also consider dynamic group identity geolocation, regional and global extended maps. AIGPR system 100 may consider entity signals to combatants (e.g., government statements, intentional leaks, recalling ambassadors for consultations, pauses, suspensions to relations).

AIGPR system 100 can take into consideration amplifiers/accelerators, which can help predict escalation and/or probabilities of an event. Examples of amplifiers/accelerators may include images/social media (sentiment analysis on photos); video/social media (sentiment analysis on video thumbnails and key frames); distribution of such through polarized agenda driven media coverage; elevating sentiment—insecurity, fear, anger on both sides of a conflict; combatant leadership speeches in English and native language—extremist rhetoric (e.g., political ideology, nationalist, ethnic and religious references)—preparing population for war to cause destruction and kill civilians with historical and religious justifications, etc.

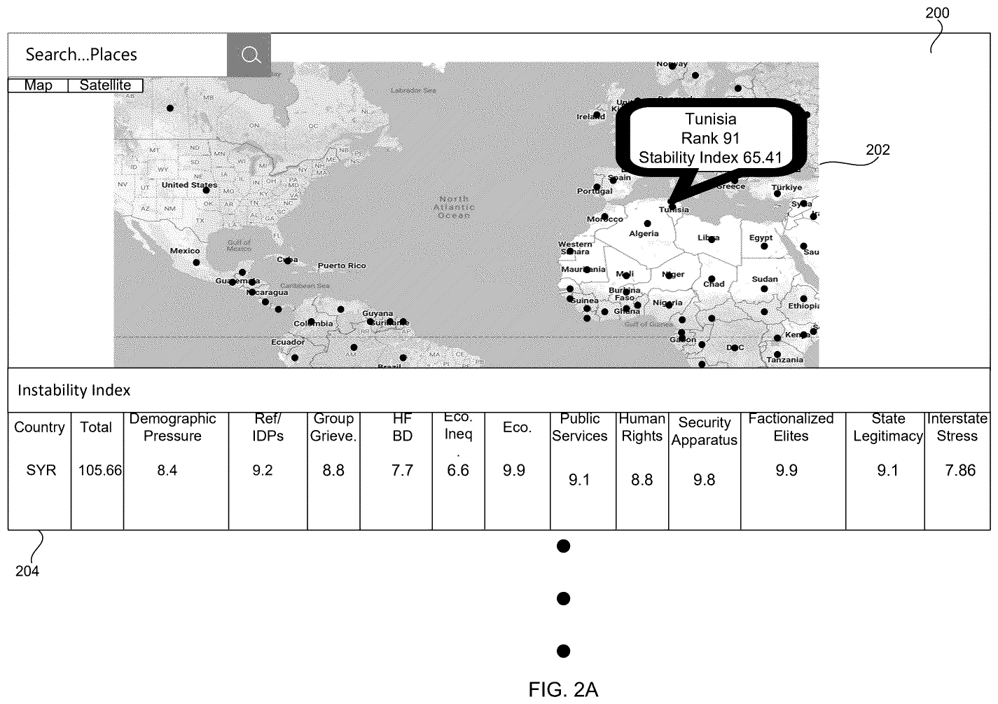

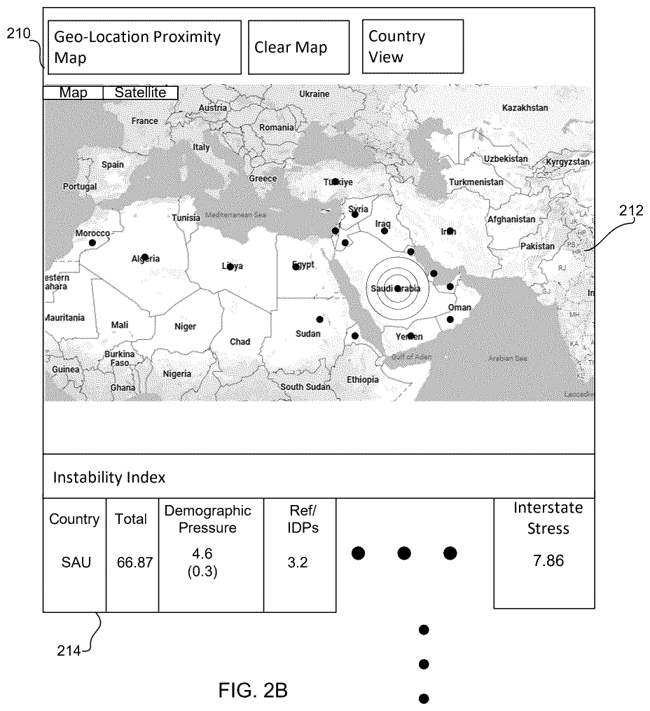

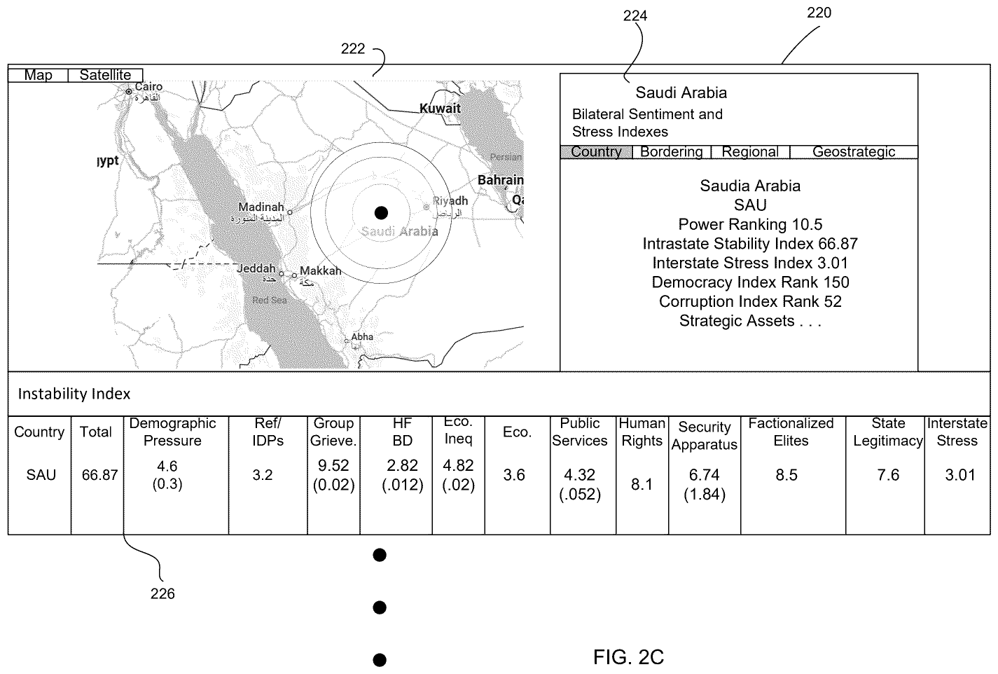

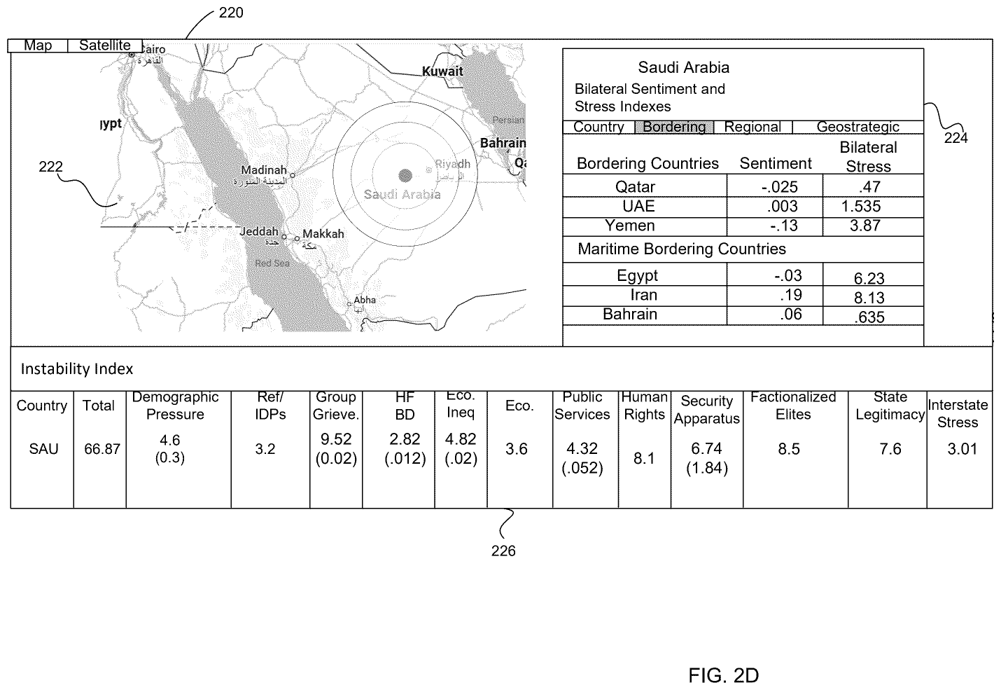

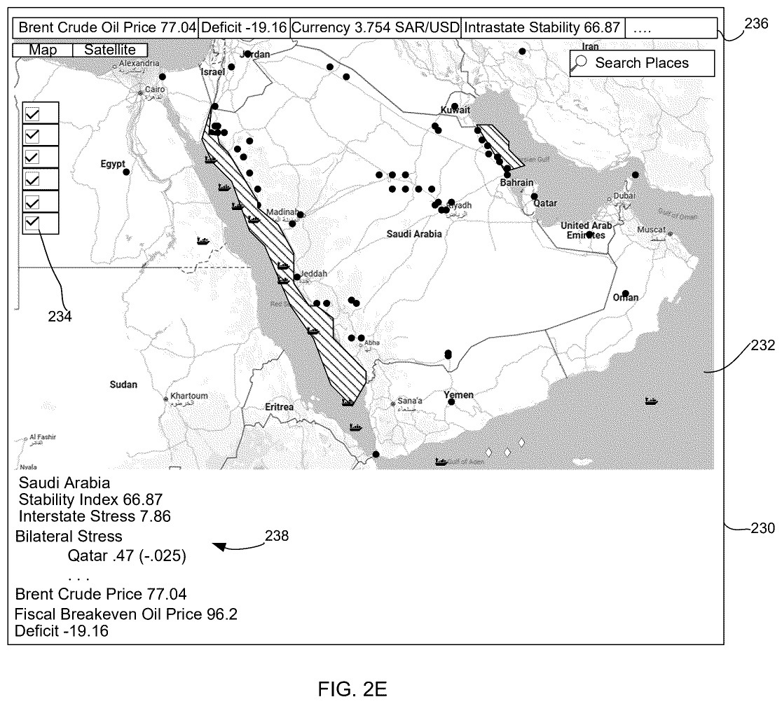

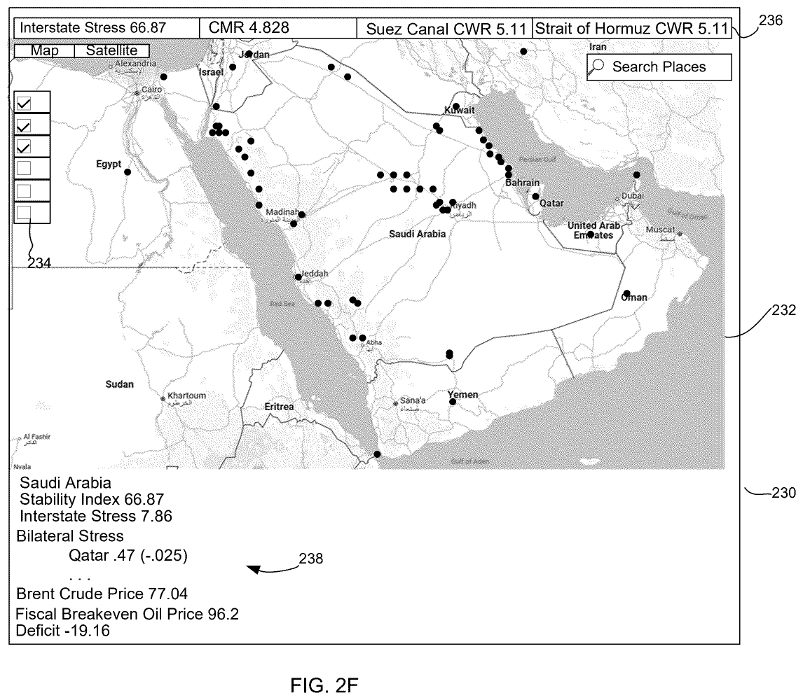

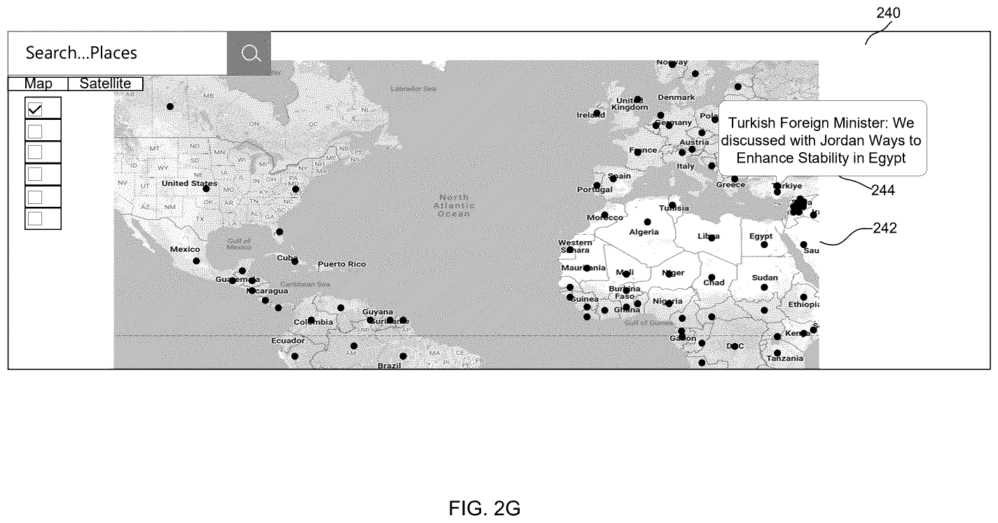

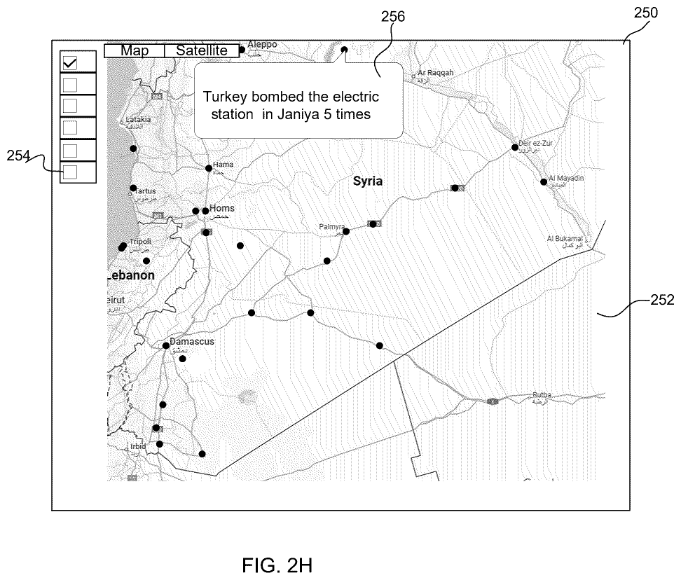

FIG. 2A is a diagrammatic representation of one embodiment of a user interface 200 provided by an AIGPR system, such as through a web browser. In the illustrated interface, the AIGPR system provides a world map 202 that the user can pan/scroll/zoom. On the map, dots/icons are shown on entities (countries). The icons can be color coded to indicate the relative level of risk of an event occurring based, for example, on the stability indicator score. In one example, a red color can indicate a relatively high risk, a green color can indicate a relatively low risk, with other colors indicating levels in between (e.g., green-yellow-orange-red). Hovering on a dot brings up relevant information about the country such as the intrastate stability indicator score and rank in the instability index.

In the example of FIG. 2A, an instability index 204 is provided below the map. The user can scroll through the countries to see the scores for each country. Instability index 204 provides the intrastate stability indicator scores determined for each entity (e.g., as forecast by the AIGPR system) with, in this example, larger numbers representing higher instability. As shown, each entity (country or nation state) corresponding values for intrastate stability indicators such as, total (composite intrastate stability indicator score), demographic pressures, refugees and IDPs, group grievance, human flight and brain drain, economic inequality, economy, public services, human rights, security apparatus, factionalized elites, state legitimacy and interstate stress. The entities are ranked based on their composite intrastate stability indicator scores. In other examples, other items can be displayed. In some embodiments, the individual scores are color coded to indicate the relative level of risk.

In some embodiments, a user can search for an entity in the search bar or click on any of the dots on the map. In response to such a user selection, the map can zoom in and show a more detailed view for the entity. FIG. 2B is a diagrammatic representation of another embodiment of a user interface 210. In the example of FIG. 2B, the user has selected Saudi Arabia and the interactive map 212 is updated to focus on Saudi Arabia. Here, the selected country and the bordering, regional, and geostrategic entities are designated in the map based on level of zoom. On the map, dots/icons are shown on the bordering, regional, and geostrategic entities (countries) visible depending on location and level of zoom. The icons can be color coded to indicate stability indicator score or otherwise indicate the relative level of risk of an event.

According to one embodiment, instability index 214 is updated to focus on the selected country, for example, displaying intrastate stability indicator scores forecast for Saudi Arabia. In this case, several of the intrastate stability indicator values are followed by a number in parentheses to indicate the change from the last determination for that indicator. Thus, for example, the security apparatus score has increased by 1.84, indicating that the security apparatus represents a greater threat to stability than it did previously. Instability index 214 may also be updated to show the indicator scores for bordering, regional, or geostrategic entities or other entities.

The user can click on the country of interest, zoom in, or take another predefined action to access further data about the entity. Turning to FIG. 2C, one embodiment of a user interface 220 illustrating a more detailed for a country is illustrated. In this example, interactive map 222 is zoomed in to a selected country (e.g., Saudia Arabia) and an information pane 224 with several tabs is provided. Instability index 226 is updated to focus on the selected country, for example, displaying intrastate stability indicator scores forecast for Saudi Arabia. Instability index 226 may include the indicator scores for bordering, regional, or geostrategic entities or other entities.

In information pane 224, the “Country” tab provides general information for the country, including, for example, the instability index score or interstate stress forecast for the country. Other tabs provide sentiment and bilateral stress scores determined with respect to other entities (e.g., Bordering, Regional, Geostrategic). FIG. 2D is a diagrammatic representation of an updated user interface in which a user has selected the “Bordering” tab. The Bordering tab of information pane 224 displays bilateral data determined for Saudi Arabia with respect to bordering countries including the sentiment of each bordering country to Saudi Arabia and the bilateral stress score determined for Saudi Arabia with respect to each bordering country. The scores can be color coded to indicate the relative level of risk. Similar data can be displayed for regional entities and geostrategic entities.

The geolocation map (e.g., map 212, map 222) includes a transparency layer of, for example, three concentric rings around a dot. The rings include event local, regional and geostrategic rings of participants with relevant dynamic information including probability metrics displayed on connected information panes to the side and below the map. For example, by selecting a ring, the user may be presented with additional data related to the ring.

In another embodiment, the system displays bordering entities associated with an event in the local ring, regional entities associated with the event in the regional ring, and geostrategic entities associated with the event in the geostrategic ring. The power of the entities can be represented by icons on the map (e.g. by the size of the icons). Alliances and alignments can be color coded or otherwise visually associated across rings (e.g., the icons representing allied/aligned entities have the same color or are otherwise indicated as aligned). Various probabilities may be displayed in the side pane.

FIG. 2D is a diagrammatic representation of a user interface 230 displaying a detailed country view for a selected country (e.g., Saudi Arabia). User interface 230 includes an interactive map 232. Icons/dots on the map represent entities such as relevant countries (e.g., the country of interest, bordering countries, regional countries, geostrategic countries), locales (e.g., cities) within the country of interest, and various sources of data or relevant items for which data is tracked. By way of example, but not limitation, power plants, refineries, mineral resources within the country, strategic resources, ships being tracked, sensor buoys providing data, critical waterways for the selected country can be represented on the map. Economic exclusionary zones for the country are also represented. Icons may be color coded based on one or more factors, such as risk, or type. In the illustrated embodiment, icons are represented in associated layers and user interface 230 includes a layer selection tool 234 to allow the user to show/hide layers.

In one embodiment, user interface 230 includes a scrolling ticker 236 of data points relevant to the country including data collected from data sources or data forecast by the AI system. In FIG. 2E, ticker 236 scrolls, for example, prices related to important resources, currency value relative to the US dollar, the intrastate stability score, the intrastate stability score. FIG. 2F illustrates further information scrolled, such as critical mineral risk index, critical waterway risks (CWR) for the critical waterways of the country. According to one embodiment, the CWR for a critical waterway is based on the average (or weighted average) of interstate stresses scores of countries that are in proximity to the critical waterway.

User interface 230 further includes an information pane 238 displaying various items of information for the selected country.

FIG. 2G is a diagrammatic representation illustrating another example of a user interface 240 for detected events/activities. In this example, the user has selected to view data for Syria. User interface 240 includes interactive map 242. Icons/dots on the map represent entities, such as relevant countries, and events, such as disruptive events, escalatory/de-escalatory actions or other events. The represented events may include activities by local, regional, and geostrategic entities. Events may be represented with icons geolocated based, for example, on the hyper-local source of data from which the event was detected. Icons may be color code based on type of event, type of entity with which the event is associated (e.g., bordering, regional, geostrategic), severity of the event, bilateral stress or other factors.

In the illustrated embodiment, icons are represented in associated layers and interface 240 includes a layer selection tool 244 to allow the user to show/hide layers. For example, one layer may be associated with military events and another layer with economic events. In response to the user hovering over an icon for an event, the system may display a snippet from a data source (e.g., a snippet from a press release related to the event) or a generated summary of the event, which may be displayed in information bubble (e.g., information bubble 246).

FIG. 2H is a diagrammatic representation illustrating another example of a user interface 250 for detected events/activities in which the user zoomed in on the country of interest in interactive map 252. Icons/dots on the map represent entities and events, which may be color coded by type. In the illustrated embodiment, icons are represented in associated layers and interface 240 includes a layer selection tool 254 to allow the user to show/hide layers. In response to the user hovering over an icon for an event, the system may display a snippet from a data source or a generated summary of the event, such as displayed in information bubble 256.

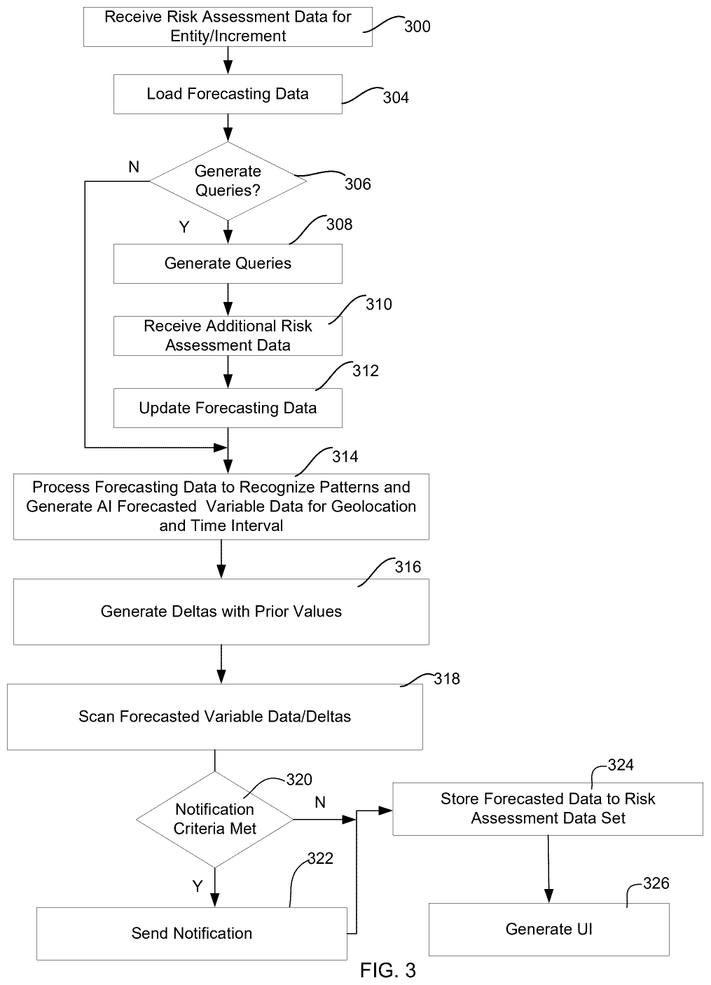

FIG. 3 illustrates one embodiment of a method for Al-based geopolitical risk assessment. In one embodiment, the steps of FIG. 3 are embodied as computer-executable instructions stored on a non-transitory, computer-readable medium. One or more steps of FIG. 3 may be implemented by AIGPR system 100.

As discussed, AIGPR system 100 includes a risk assessment dataset 115 that represents a series of states of the world at small increments with respect to geopolitical risk collected from a worldwide network of data sources including, but not limited sources of hyper-localized data. Various events can trigger analysis of data for an entity or set of entities including, for example, updated risk analysis data for an entity (step 300). AI engine 126 loads risk assessment forecasting data (e.g., into volatile memory if not already loaded) (304). The risk assessment forecasting data includes current/recent variable data (e.g., variable data for times in the last n months, last n weeks, last n minutes, last n seconds, last n milliseconds). In some embodiments, different time increments may be used for different variables.

At step 306, AI engine 126 scans recently received risk assessment data to determine if new queries should be issued, for example if there has been a change in pattern from the previous state (e.g., variables dropping out, new variables added) or data missing that requires additional data to be ingested. If AI engine 126 determines that new queries are to be generated, AI engine 126 spontaneously generates the queries to query data sources for data to confirm, augment, or understand the risk assessment data (step 308). In some embodiments, the queries may be generated based on rules according to which data has changed or is missing. Thus, new data is received (step 310) and the risk assessment forecasting data is updated (step 312).

At step 314, the forecasting data with the time increment for which a forecast is requested is processed by AI-engine 126 to identify patterns in terms of variables that trend together, the sequence/order in which the variables move and the velocity of movement of each respective variable in relation to the other variables. From these patterns of variables that trend together, order in which the variables move and the respective velocities, the AI engine 126 forecasts variable values for the time increment. According to one embodiment, AI engine 126 forecasts one or more of a probable disruptive event and likely participants, a probable escalatory/de-escalatory event with likely participants, a value for an interstate stress indicator, a value for an intrastate stress indicator.

In one embodiment, AI-engine 126 determines the deltas of the values of one or more forecasted variables from the prior values for the variables (step 316). For example, AI-engine 126 may determine the deltas of one or more risk indicator values from the values of the risk indicators from a previous assessment.

At step 318, AIGPR system 100 scans the forecasted variables and, at step 320, determines if a notification/warning should be generated. In one embodiment, AIGPR system 100 generates notifications/warnings based on one or more of a predicted disruptive event, a risk indicator value, a delta determined for a risk indicator value (step 322). AIGPR 110 can send alerts by email, text, web interface or another channel based on configuration. In some embodiments, the severity of the alert is based on the severity of the probable disruptive event, the severity indicated by a risk indicator value or the size of a delta determined for the forecasted data.

The forecasted data can be stored as forecasted values to the risk assessment dataset (step 324). The forecasted data, at step 326, is used in generating a dynamic user interface with geolocated data including, for example, forecasted data.

FIG. 3 is merely an illustrative example, and the disclosed subject matter is not limited to the ordering or number of steps illustrated. Embodiments may implement additional steps or alternative steps, omit steps, or repeat steps.

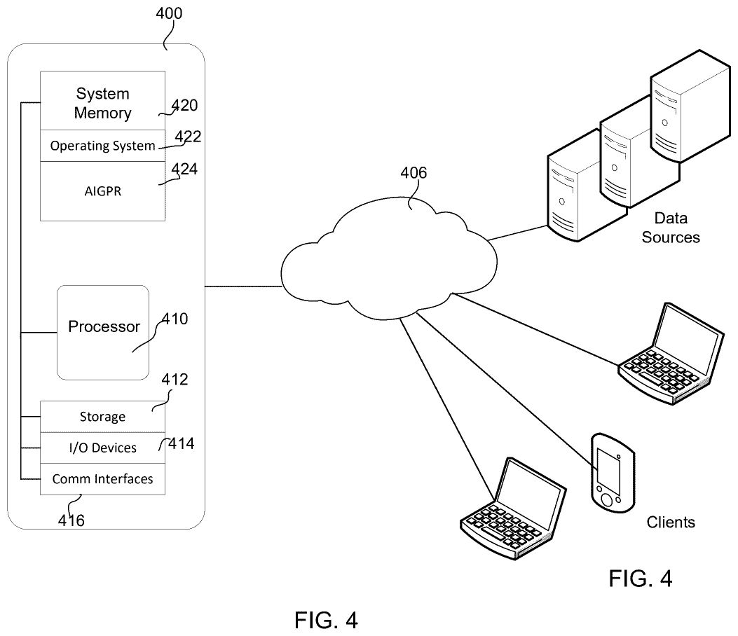

FIG. 4 is a diagrammatic representation of one embodiment of a computing environment that includes AIGPR system 400, which represents one embodiment of AIGPR system 400 or another AIGPR system 400, connected to client computers and data sources via a network 406. AIGPR system 400, according to one embodiment, is a cloud computing system.

AIGPR system 400 includes a processor 410 and memory 420. Memory 420 (storing, among other things, executable instructions) may be volatile (such as RAM), non-volatile (such as ROM, flash memory, etc.), or some combination of the two. Further, AIGPR system 400 may also include storage devices 412, such as, but not limited to, solid state storage. AIGPR system 400 may also have input device(s) and output device (I/O devices 414) such as keyboard, mouse, pen, voice input, touch screen, speakers. AIGPR system 400 further includes communications interfaces 416, such as a cellular interface, a Wi-Fi interface, or other interfaces.

AIGPR system 400 includes at least some form of non-transitory computer-readable media. The non-transitory computer-readable readable media can be any available media that can be accessed by processor 410 or other devices comprising the operating environment. By way of example, non-transitory computer-readable media may comprise computer storage media such as volatile memory, nonvolatile memory, removable storage, or non-removable storage for storage of information such as computer readable-instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information.

As stated above, a number of program modules and data files may be stored in system memory 420. While executing on processor 410, program modules (e.g., applications, Input/Output (I/O) management, and other utilities) may perform processes including, but not limited to, one or more of the stages of the operational methods described with respect to AIGPR system 400. In one embodiment, system memory 420 stores an operating system 422 and an AIGPR application 424. System memory 420 may include other program modules such as program modules to provide analytics or other services. Furthermore, the program modules may be distributed across computer systems in some embodiments.

Portions of the methods described herein may be implemented in suitable software code that may reside within RAM, ROM, a hard drive or other non-transitory storage medium. Alternatively, the instructions may be stored as software code elements on a data storage array, magnetic tape, floppy diskette, optical storage device, or other appropriate data processing system readable medium or storage device.

Although the invention has been described with respect to specific embodiments thereof, these embodiments are merely illustrative, and not restrictive of the invention as a whole. Rather, the description is intended to describe illustrative embodiments, features and functions in order to provide a person of ordinary skill in the art context to understand the invention without limiting the invention to any particularly described embodiment, feature or function, including any such embodiment feature or function described in the Abstract or Summary. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention.

Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Software implementing embodiments disclosed herein may be implemented in suitable computer-executable instructions that may reside on a computer-readable storage medium. Within this disclosure, the term “computer-readable storage medium” encompasses all types of data storage medium that can be read by a processor. Examples of computer-readable storage media can include, but are not limited to, volatile and non-volatile computer memories and storage devices such as random-access memories, read-only memories, hard drives, data cartridges, direct access storage device arrays, magnetic tapes, floppy diskettes, flash memory drives, optical data storage devices, compact-disc read-only memories, hosted or cloud-based storage, and other appropriate computer memories and data storage devices.

Those skilled in the relevant art will appreciate that the invention can be implemented or practiced with other computer system configurations including, without limitation, multi-processor systems, network devices, mini-computers, mainframe computers, data processors, and the like. The invention can be employed in distributed computing environments, where tasks or modules are performed by remote processing devices, which are linked through a communications network such as a LAN, WAN, and/or the Internet. In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks).

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention. At least portions of the functionalities or processes described herein can be implemented in suitable computer-executable instructions. The computer-executable instructions may reside on a computer readable medium, hardware circuitry or the like, or any combination thereof.

Any suitable programming language can be used to implement the routines, methods or programs of embodiments of the invention described herein, including C, C++, Java, JavaScript, HTML, or any other programming or scripting code, etc. Different programming techniques can be employed such as procedural or object oriented. Other software/hardware/network architectures may be used. Communications between computers implementing embodiments can be accomplished using any electronic, optical, radio frequency signals, or other suitable methods and tools of communication in compliance with known network protocols.

As one skilled in the art can appreciate, a computer program product implementing an embodiment disclosed herein may comprise a non-transitory computer readable medium storing computer instructions executable by one or more processors in a computing environment. The computer readable medium can be, by way of example only but not by limitation, an electronic, magnetic, optical or other machine-readable medium. Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices.

Particular routines can be executed on a single processor or multiple processors. Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. Functions, routines, methods, steps and operations described herein can be performed in hardware, software, firmware or any combination thereof.

It will also be appreciated that one or more of the elements depicted in the drawings/figures can be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only to those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated otherwise (i.e., that the reference “a” or “an” clearly indicates only the singular or only the plural). Also, as used in the description herein and throughout the meaning of “in” includes “in” and “on” unless the context clearly dictates otherwise.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Generally then, although the invention has been described with respect to specific embodiments thereof, these embodiments are merely illustrative, and not restrictive of the invention. Rather, the description is intended to describe illustrative embodiments, features and functions in order to provide a person of ordinary skill in the art context to understand the invention without limiting the invention to any particularly described embodiment, feature or function, including any such embodiment feature or function described. While specific embodiments of, and examples for, the invention are described herein for illustrative purposes only, various equivalent modifications are possible within the spirit and scope of the invention, as those skilled in the relevant art will recognize and appreciate.

As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

What is claimed is:

1. A method for artificial intelligence (AI)-based global geopolitical risk assessment and warning, the method comprising:
continuously collecting cross-sector data related to geopolitical risk from a worldwide network of data sources to update a risk assessment dataset comprising a series of risk assessment states for a plurality of geopolitical entities in time increments;
selecting forecasting risk assessment data from the risk assessment dataset for assessing risk for a selected time increment and a first entity from the plurality of geopolitical entities;
processing the forecasting risk assessment data using an inquisitive artificial intelligence engine to identify a pattern and trend in the forecasting risk assessment data and use the pattern and trend to forecast risk assessment variable values for the first entity to generate forecasted risk assessment variable data, wherein the comprises a forecasted value for at least one indicator geopolitical risk to the first entity; and
dynamically generating a user interface comprising an interactive map for a user, the interactive map embodying the forecasted risk assessment variable values to display a forecasted risk for the first entity to the user in association with the first entity in the user interface.

2. The method of claim 1, further comprising synchronizing global observation of atmospheric, terrestrial, and oceanic conditions, human activity, and artificial systems across geographic regions.

3. The method of claim 1, wherein the forecasting risk assessment data comprises first values for a plurality of intrastate risk indicators and intrastate risk variables for the first entity and where the forecasted risk assessment variable data comprises forecasted values for the plurality of intrastate risk indicators.

4. The method of claim 1, wherein the forecasting risk assessment data comprises an indicator of a first escalatory action associated with escalating interstate tension and wherein the forecasted risk assessment variable data identifies a probable escalatory action for the first entity.

5. The method of claim 4, further comprising processing text input from a plurality of hyper localized documents to identify, using a plurality of signals, the first escalatory action.

6. The method of claim 4, further comprising generating a bilateral stress score for the first entity using the probable escalatory action.

7. The method of claim 6, wherein the forecasted risk assessment variable data identifies a second entity as an anticipated participant in the probable escalatory action, and wherein the bilateral stress score is determined for the first entity with respect to the second entity.

8. The method of claim 1, wherein the forecasting risk assessment data comprises alliance and associations data, disruptive event data, economic index rankings, military index rankings, and activity data, wherein the forecasted risk assessment variable data comprises an indicator of a probable disruptive event.

9. The method of claim 8, wherein the probable disruptive event is selected from a group consisting of: social unrest, regional conflict, war, political instability, terrorist attack, cyberattack, trade tensions and disputes leading to disruptions of trade flows, sovereign debt crises, disruptive capital flow, currency fluctuations that affect cross-border payment value, sanctions, and tariffs.

10. The method of claim 1, further comprising:
receiving new variable values for the selected time increment, the new variable values extracted or derived from new input data from the worldwide network of computers; and
automatically relearning, by the inquisitive AI engine, the pattern and trend using the new variable values.

11. The method of claim 1, further comprising the inquisitive AI engine spontaneously generating a query to a data source to collect additional risk assessment data.

12. The method of claim 1, wherein identifying the pattern and trend comprises identifying variables that trend together, an order in which the identified variables move, a velocity of movement of each of the respective identified variables in relation to others of the identified variables.

13. The method of claim 1, wherein the forecasting risk assessment data corresponds to a plurality of increments prior to the selected time increment.

14. A system for artificial intelligence (AI)-based global geopolitical risk assessment and warning, the system comprising:
a processor;
a volatile memory coupled to the processor;
a second memory coupled to the processor storing:
a granular dynamic risk assessment dataset collected from a worldwide network of data sources a series of risk assessment states for a plurality of geopolitical entities in time increments;
code executable to provide an inquisitive artificial intelligence engine, comprising computer-executable instructions executable by the processor for:
receiving an indication to generate a forecast for a first entity and a first time increment;
loading into the volatile memory, forecasting risk assessment data for a defined time increment, the risk assessment data comprising data indicative of geopolitical risk;
analyzing by the inquisitive artificial intelligence engine the forecasting risk assessment to identify a pattern and trend in the forecasting risk assessment data and use the pattern and trend to forecast risk assessment variable values for the first entity to generate forecasted risk assessment variable values, the forecasted risk assessment variable values comprising at least one of an indication of a probable disruptive event, an intrastate stability score, an interstate stress score; and
dynamically generating a user interface comprising an interactive map for a user, the interactive map embodying the forecasted risk assessment variable values to display a forecasted risk for the first entity to the user in association with the first entity in the user interface.

15. The system of claim 14, wherein the code further comprises instructions executable for generating an automatic notification of geopolitical risk based on the forecasted risk assessment variable values.

16. The system of claim 14, wherein the inquisitive artificial intelligence engine is executable to observe dynamic movement of variables across sectors to recognize the pattern and trend.

17. The system of claim 14, wherein the forecasting risk assessment data comprises risk assessment variable values extracted or derived from hyper-localized data associated with the first entity.

18. The system of claim 14, wherein the defined time increment comprises a plurality of time increments prior to the first time increment.

19. The system of claim 14, wherein the code is further executable to process text input from a plurality of hyper localized documents to identify, using a plurality of signals, a first escalatory action by a second entity with respect to the first entity, wherein the forecasted risk assessment variable values indicate a probable escalatory action by the second entity with respect to the first entity.

20. A non-transitory, computer-readable medium embodying thereon computer-executable code, the computer-executable code comprising instructions executable for:
maintaining a granular dynamic risk assessment dataset collected from a worldwide network of data sources a series of risk assessment states for a plurality of geopolitical entities in time increments;
receiving an indication to generate a forecast for a first entity and a first increment;
loading into volatile memory, forecasting risk assessment data for a defined time increment, the forecasting risk assessment data comprising data indicative of geopolitical risk;
analyzing by an inquisitive artificial intelligence engine the forecasting risk assessment to identify a pattern and trend in the forecasting risk assessment data and use the pattern and trend to forecast risk assessment variable values for the first entity to generate forecasted risk assessment variable data, the forecasted risk assessment variable values comprising at least one of an indication of a probable disruptive event, an intrastate stability score, an interstate stress score; and
dynamically generating a user interface comprising an interactive map for a user, the interactive map embodying the forecasted risk assessment variable values to display a forecasted risk for the first entity to the user in association with the first entity in the user interface.
